(19) United States
(12) Patent Application Publication
(10) Pub. No.: US 2003/0133185 A1
(43) Pub. Date: Jul. 17, 2003

(54) Barrier and window for an optics head

(76) Inventors: Murray Robert Dunn, Encinitas, CA (US); Richard G. Trissel, Cardiff, CA (US); James Plante, San Diego, CA (US)

Correspondence Address: Joseph Page, P.O. Box 757, La Jolla, CA, 92038, US

(21) Appl. No.: 10/045,176

(22) Filed: Jan. 11, 2002

(51) Int. Cl. G02B 1/00; G02B 5/08; G02B 5/20; F21V 9/04; F21V 9/06; G02B 5/28; G02B 5/22; G02B 7/00

(52) U.S. Cl. 359/361; 359/350; 359/359; 359/589; 359/892

(57) ABSTRACT

Windows for infrared Mid-IR optical systems include thin film materials stretched over a rigid frame. The windows form a barrier between sensitive optics in an optic head and damaging elements of weather and environment. Windows and methods for making windows for free space optics communications systems include use of specialized materials and structural components to form durable inexpensive barriers in agreement with these inventions. Barriers can be used to provide protection of optics contained in an optical transceiver from an atmosphere composed of matter hostile to optics elements. The barrier can operate in conjunction with an enclosure housing to form a complete barrier between those optics and that atmosphere. These windows may be removable from the housing for replacement or maintenance. Advanced versions of these windows may also include specialized condensation prevention means. These windows are particularly characterized by their large area aperture and ability to pass middle infrared, Mid-IR, optical radiation without excessive attenuation. This is partly realized by way of special handling in the formation of the windows. In addition, these windows are quite inexpensive to manufacture, they have exceptional lifetimes and can be formed to be replaceable at the expiration of their useful lifetime.

### BACKGROUND OF THE INVENTION

1. Field

The field of these inventions described herefollowing may best be characterized as barriers for optical systems and more specifically barriers for optical heads in gaseous atmospheres permitting transmission of infrared optical radiation through large area apertures.

2. Prior Art

Many optical systems employing infrared wavelengths are accompanied by need for an infrared window. Typically, optical components including detectors, lenses and so forth are contained in a housing or enclosure sometimes called an optics head. To couple the optical components with infrared radiation propagating in an atmosphere, a window element is generally provided. The window is a barrier to contaminants while providing transmission of the desired optical energy.

These window elements typically serve various objectives depending upon the precise nature of the application at hand. Accordingly, configurations of many types of windows populate the art. These include techniques and devices to improve the use of known materials such as zinc selenide or zinc sulfide, to enhance the open area possible with materials otherwise limited in this way, to form sandwiched configurations yielding combinations of effects. These and other objectives can be more readily understood and appreciated in view of the following US patents relating to infrared windows or IR windows.

Inventor Feng et al, teach infrared windows fabricated by direct bonding in U.S. Pat. No. 6,181,468. In this teaching, a conventional IR window is bonded to a protective layer to be exposed to harsh environments which might involve impacts with destructive matter. The protective layer after becoming damaged is removed from the conventional window in a heating process. A new ‘fresh’ protective layer is thereafter bonded onto the surface of the conventional substrate in a heating process. In this way, the expensive optical element is not damaged by environments which otherwise tend to harm or destroy sensitive optical surfaces.

U.S. Pat. No. 5,851,631 includes teaching directed to a special layered approach to provide strength and impact resistance in a single IR window for use in automotive environments which are harsh against optical components. A low cost, long wave window is realized by bonding a polyethylene plastic film via an acrylic adhesive to a silicon substrate. The film may be as thin as 0.001-0.007 of an inch to provide a particle absorbing layer.

Yamagishi forms transparent IR materials having plasma polymerized saturated hydrocarbon coatings in U.S. Pat. No. 4,390,595. The coatings provide good IR transmission, effective moisture barrier, resistance against oxidation and abrasion.

A conventional IR window made of a salt material is improved by providing thereon layers of antireflective coatings. In U.S. Pat. No. 5,425,983, inventor Propst et al show how to lay materials such as germanium, diamond like carbon. Further, alternating layers of germanium and diamond like carbon are formed in compression and tension respectively to yield an improved window system.

In both U.S. Pat. Nos. 5,575,959 and 5,643,505, Harris et al show a process for making low cost infrared windows. Using a ceramic powder processing rather than the more expensive chemical vapor deposition, Harris et al present a technique to form a window. In addition, means for hardening and strengthening the window are taught.

A special mechanical arrangement which cooperates with objectives of use of infrared windows is considered and disclosed as recent U.S. Pat. No. 6,318,035. A frame assemble is formed to allow an IR window mounting function which is useful in view of the intended application.

As large area apertures are required in some specialized applications, IR windows are sometimes designed around the problem of providing a window with large surface areas. For example, cadmium telluride is a crystal which is transparent to most useful IR wavelengths. However, the crystals are not easily grown in boules having a diameter greater than about two inches. Consequently, alternative arrangements must be considered when forming a large area aperture IR window and these may include inventions such as that of Hoggins et al, U.S. Pat. No. 5,525,802. A honeycomb structure is formed to support a plurality of cells into which an IR transmisive material can be applied. Similarly, Wu et al suggests ion beam deposition of diamond-like carbon material onto special substrates to form large area aperture IR windows. Also, Klocek et al teach a polymeric optical systems which is further accompanied by means relating to interference shields and diffractive lenses together to form a large area aperture IR window.

While the systems and inventions of the art are designed to achieve particular goals and objectives, some of those being no less than remarkable, these inventions have limitations which prevent their use in a manner consistent with applications taught herein. These inventions of the art are not used and cannot be used to realize the advantages and objectives of the present invention.

### SUMMARY OF THE INVENTION

Comes now, Murray Dunn, Richard Trissel, and James Plante with inventions of barrier windows for optics systems employing middle infrared Mid-IR optical radiation including apparatus and methods. It is a primary function of these inventions to provides free space optical communications systems a barrier between an optics head and an open atmosphere. It is a contrast to prior art methods and devices that systems of the art do not provide inexpensive large area aperture windows for middle infrared wavelengths. A fundamental difference between barriers of these instant inventions and those of the art can be found when considering their mechanical configurations and techniques of forming those configurations.

Windows and methods for making windows for free space optics FSO communications systems include use of specialized materials and structural components to form durable inexpensive barriers. The barrier can be used to provide protection of optics contained in an optical transceiver from an atmosphere composed of matter hostile to optics elements. The barrier can operate in conjunction with an enclosure housing to form a complete barrier between those optics and that atmosphere. These windows may be removable from the housing for replacement or maintenance. Advanced versions of these windows may also include specialized condensation prevention means. These windows are particularly characterized by their large area aperture and ability to pass middle infrared, Mid-IR, optical radiation without excessive attenuation. This is partly realized by way of special handling in the formation of the windows. The thickness of thin films from which these windows are comprised are highly uniform and the absolute thickness is tightly controlled in process steps to realize an anti-reflection function. In addition, these windows are quite inexpensive to manufacture, they have exceptional lifetimes and can be formed to be replaceable at the expiration of their useful lifetime. In accordance with systems requirements, these barrier windows cooperate with the objectives and parameters relating to free space optics communications optical system applications.

The invention thus stands in contrast to methods and devices known previously; neither of which will serve the FSO application well. These inventions include thin film barrier windows of special large area aperture configuration and methods of forming same. In contrast, the art includes arrangements of mosaic elements and sandwich layers of a plurality of materials, among others.

### OBJECTIVES OF THE INVENTION

It is a primary object of the invention to provide a window for infrared light.

It is an object of the invention to provide a window and barrier combination.

It is an object of the invention to provide a window and barrier for an optics head in a free space communications system.

It is also an object to provide barrier windows which cooperate with a quick changing mechanism for replacing aged barrier windows.

It is an object in some versions to provide a barrier window having atmospheric control facility.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by the claims, but do not appear here as specific examples. It will be appreciated that a great plurality of alternative versions are possible.

### BRIEF DESCRIPTION OF THE DRAWING FIGURES

These and other features, aspects, and advantages of the present invention will become better understood with regard to the following description, appended claims and drawings where:

FIG. 1 is a perspective illustration of window components;

FIG. 2 shows the components as they are integrated together;

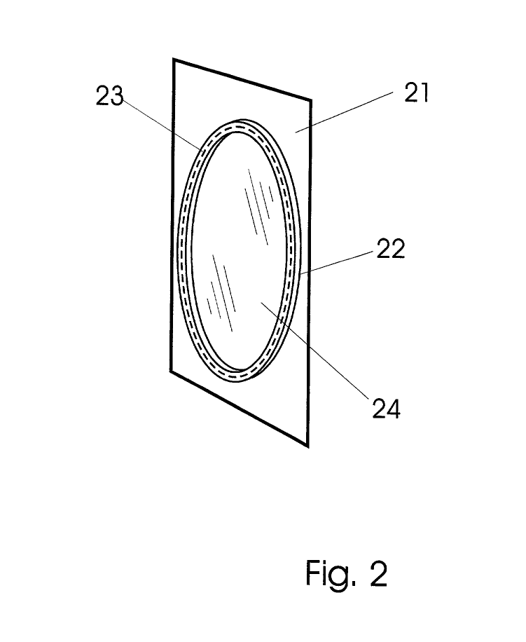

FIG. 3 illustrates a step after heat is applied to cause a shrinking action with regard to a thin film;

FIG. 4 shows an element after a trimming step has removed excess material;

FIG. 5 is an exploded view perspective drawing along an axis of a multi-piece device;

FIG. 6 illustrates an assembled version in a perspective view;

FIG. 7 is a cross sectional view of and element and its coupling to an optics head;

FIG. 8 is an alternative version having a special function element integrated therewith;

FIG. 9 is a perspective drawing illustrating coupling to an optics head;

FIG. 10 is a second preferred version of a similar coupling;

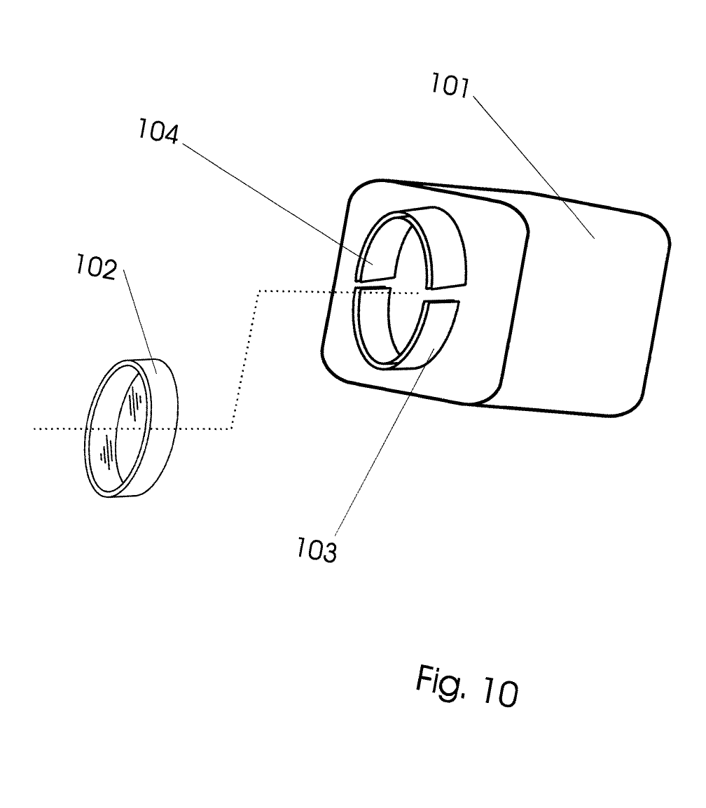

FIG. 11 illustrates optical waves reflected from window surfaces; and

FIG. 12 illustrates superposition of reflected waves to produce a canceling effect.

### GLOSSARY OF SPECIAL TERMS

Throughout this disclosure, reference is made to some terms which may or may not be exactly defined in popular dictionaries as they are defined here. To provide a more precise disclosure, the following terms are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must use the context of use and liberal discretion to arrive at an intended meaning. One will be well advised to error on the side of attaching broader meanings to terms used in order to fully appreciate the depth of the teaching and to understand all the intended variations.

‘Mid-IR’ or Middle Infrared

Mid-IR radiation includes optical wavelengths from about 3 microns to about 20 microns. With recognition that some writings suggest different definitions for a middle infrared region of the spectrum, this definition is useful for guidance in consideration of concepts disclosed here. It is common with some authors to consider wavelengths of 20 microns ‘long-wave’ IR. This should not suggest an inconsistency because the ambiguity is common in the art.

Barrier

Barriers of these inventions are optical elements configured to pass optical energy but provide a barrier to gases and gas currents, dirt, water vapor, among others.

Thin Film

Thin film is a polymer sheet material of thickness no greater than one eighth of one inch. Thin films of these inventions are electrical insulators.

Large Area Aperture

A ‘large’ area aperture is an aperture greater than three centimeters in diameter.

In addition to terms described above, for purposes of this disclosure full meaning of the noun phrase: “condensation prevention means”, which is functional in nature, may be more readily appreciated in view of the following note:

Condensation Prevention Means

A condensation prevention means is apparatus or material arranged to prevent condensation. In many embodiments of the invention the condensation prevention means is a simple desiccant carefully applied. In other versions, a condensation prevention means is a heating mechanism. In some versions, a double pane window is arranged with atmospheric control between panes. The condensation prevention means therefore performs the function of preventing condensation. Many forms of alternative forms of condensation prevention means may be used to accomplish the identical task. The particular condensation prevention means employed may be chosen for a particular application having circumstances different than another application. For example a system employing a double pane would not be appropriate for a first type of condensation prevention means so an alternative technique may be preferred in those systems. The essence of the invention is not changed by the particular choice of condensation prevention means. Therefore versions of the invention should not be limited to any particular type. The limitation described by ‘condensation prevention means’ is met when condensation is prevented. Therefore, by use of the term ‘condensation prevention means’ it is meant that any conceivable means for preventing condensation is contemplated. The reader will appreciate that the broadest possible definition of ‘condensation prevention means’ is intended here.

Terms functional in nature like ‘condensation prevention means’ above may be used throughout this disclosure including the claims. For example, ‘means for’ or ‘step for’ followed by a phrase describing a function. One should remain aware that any particular means which may be later provided as an example is not meant to limit the ‘means for’ to that example but rather the example is provided to further illustrate certain preferred possibilities. Thus the ‘means for’ or ‘step for’ should not be limited to any particular structure which may be called out but rather to any conceivable means of causing the function described to be effected. The reader will recognize it is the function to be carried out which is the essence of the invention and many alternative means for causing the function to occur may exist without detracting from any particular combination or combinations taught as part of these inventions.

### PREFERRED EMBODIMENTS OF THE INVENTION

In accordance with each of the preferred embodiments of the invention, there is provided barrier window apparatus and methods of forming such barrier windows. It will be appreciated that each of the embodiments described may include both apparatus and methods and that an apparatus or method of one preferred embodiment may be different than an apparatus or method of another embodiment.

Basic structures of preferred embodiments include at least a thin film tightly held over a rigid frame. The frame supports the thin film in a plane whereby the film is held flat and secure. The thin film and the frame are formed in separate process steps. Thereafter they are affixed to each other in a bonding step. Some versions include windows of multiple panes. Some versions have a condensation reduction means incorporated with the window. An antireflection function can be provided in preferred thin films presented here. These functions and structures among others will become more readily apparent in consideration of the following disclosure.

Frame

A frame forms a structural member upon which thin film is supported. The frame may be a closed loop and is sometimes, although not necessarily, circular. It may be made from a strong and rigid material such as metal, ceramic or plastic. These frames have an aperture therein, that aperture typically being a square decimeter or more in area. Some ideal versions may include those of a circular ring frame having a diameter of at least 15 centimeters. The frame may also support coupling means for integration with related systems components. This may include a coupling with respect to the thin films affixed to the frames. In addition, the frames may be arranged to couple the window assembly to an optics head enclosure housing. These coupling features of the frame element are more fully described as follows.

Preferred frames should have a surface appropriate for having affixed thereto, thin film plastic. That bonding surface should cooperate with the specific type of plastic material and adhesives which may be used to affix thin film materials to the frame. A suitable surface may be flat and smooth as necessary to accommodate good bonding. The surface should include enough area that a strong bond may be formed as the bond strength may depend upon the extent of that area. The bonding surface area should be at least approximately in the same plane of thin film material when it is set and held to the frame. Where adhesives are used to provide a bond between a frame and a sheet of thin film, those adhesive must be compatible with both the material from which the frame is made as well as the polymer material of the thin film. Where a special bond is formed between the frame and the thin film by way of plastic fusion or a ‘weld’ type bond, the material from which the frame is constructed must cooperate with plastic welding and the surface can be prepared to facilitate those types of bonds.

In addition, the frame may have mechanical cooperation in support of being coupled to a mounting means integrated with another system component. For example, a threaded outer periphery may be used to couple the frame mechanically to an optics head enclosure housing having thereon a complementary thread. Alternatively, the frame may be constructed of such a shape and size that it fits snugly into a receiving cavity designed to hold the frame thereby mechanically locking it in place. Thus an enclosure housing may include a portion which is complementary in shape with regard to windows of these inventions. Further, that mount may be arranged whereby a very simple operation allows persons without specialized skills in optical instrument engineering and maintenance to change a window should it become dirtied or damaged.

The frame is preferably made of a material having a low thermal expansion coefficient. Excess expansion and contraction in response to temperature changes natural in any environment tend to upset the regularity and uniformity of the thin film. Therefore, a frame is preferred where it does not suffer from large changes in size in response to changes in temperature. Also, a system is in more perfect harmony where the coefficient of thermal expansion of the frame is matched or nearly matched with that coefficient of the film. In this way, the two elements expand and shrink together reducing problems related to unequal size changes. Normal operation of thin film windows in free space optics communications systems will be accompanied by temperature changes of several tens of degrees and perhaps as great as on the order of 100 degrees Fahrenheit. Although some resiliency in preferred polymer thin films will respond in kind with a contraction in falling temperatures, it is preferred not to place too great an expectation for the thin film to respond to size changes of the frame due to thermal variations. In some instances, ceramic materials having very low thermal expansion coefficients may be used to form frames for barrier windows.

Thin Film Materials

Some preferred thin films useful in versions of these inventions include thin films of plastic, or more precisely thin polymer films. For example, polyvinylchloride or polyethylene.

Extruded sheets of a polyolefin, an example is polyethylene, can be made with extraordinary uniformity. In addition, it may be inexpensively made and may be made quite thin. In addition, shrinking properties are highly predictable and controllable. These properties, not readily associated with other window materials and technologies, permits this special use of thin films in these unique combinations to form optical windows having good Mid-IR transmission and very high durability.

While most materials used as optical windows are transparent at the design wavelength, most thin film polymer materials are not exactly transparent. Even optical experts would not likely choose polyethylene for ten micron optics systems because the material does display significant absorption at that wavelength. Thus it is counter intuitive to use these materials for optical windows. The genius lies in the ability to form polymers in very thin uniform sheets. While the absorption coefficient is appreciable, the cross section or interaction length is very low where the films are thin. Thus, while polymers are not known as Mid-IR windows, a thin film of polymer can be arranged to pass an optical beam of these wavelengths without excess absorption. At the same time, the film remains a strong barrier to contaminants.

In some versions, it is preferred to use copolymers to achieve particular properties. A copolymer of ethylene and vinyl acetate (EVA) may be used where it is desirable that the window function in cold weather. This copolymer retains some elasticity after shrinking, i.e. it doesn't become brittle in cold weather, and is puncture and even flame resistant. Some of these specialized polymers may be arranged to ‘breath’ thereby resulting in anti-fog properties. Multilayered, cross-linked polyolefin sold under a trademark ‘Cryovac RD-106’ in one film marketed as one which prevents fogging without external apparatus.

Experts in optical sciences will fully appreciate the design requirement that the surface of an optical component be highly regular and smooth. An optical component characterized as a window is one which in most cases is preferably flat and smooth. Most windows are therefore carefully polished to achieve a flat surface. Windows of these inventions will not cooperate with polishing processes. Therefore, these windows realize a flatness by way of alternative mechanisms. In particular, the natural recoil of polymer materials can produce a force to pull the film taught over a holding frame.

Polymers are comprised of very large molecules. In some cases, these molecules tend to have many branches and have quite chaotic structures. However, under application of heat, these molecules can be pulled into a roughly linear molecule. By removing heat while holding the polymer material in its stressed state, the molecules will ‘set’ or ‘freeze’ in their unnatural linear arrangement. If heat is applied thereafter removal of the holding means, the molecules will return to their natural crinkled state resulting in a macro shrinking action. This is the principle behind thin film materials commonly called ‘shrink wrap’. The tendency for heated polymers to return to their pre-stressed shape is useful in many ways. One of these ways includes for pulling the thin film tightly over a frame to form a uniform flat surface.

A stretched and cooled sheet of thin film polymer having molecules linearized can be affixed to a frame surface suitably arranged for bonding. In example, an adhesive compatible with polymer plastics can be applied to a smooth frame surface of sufficient area for forming a complete and firm bond. Thereafter, a thin film material can be applied to the frame bonding surface whereby the thin film is joined with and affixed to the frame at its bonding surface. After sufficient time in which an adhesive cures, or the thin film is otherwise bonded to the frame, a heating step is applied.

Double-Panes

Some preferred versions include a double pane arrangement. Two sheets of thin film polymer spatially removed from one another and held in a coaxial configuration by a body member form a single barrier window of two panes. It is possible to form windows of more than two panes as well. One reason to form a window of two panes is to provide a buffer region between the panes which might be used for atmospheric control. Some systems having condensation control means might condition air between two panes to prevent condensation on either. Thus, a single ‘window’ is sometimes a configuration comprising more than one thin film sheet.

Enclosure Housing Coupling

Optics heads in some preferred versions include a window mount or holder including a receiving cavity for ‘quick change’ removing and replacing of windows. When a window becomes dirty or otherwise contaminated, it can be replaced easily by removal and replacement with a new window. An optics head enclosure housing is therefore arranged to facilitate the function of changing windows as needed. The function is considered necessary in view of the fact that thin film windows are not as durable as windows made from glass or other bulk materials. Also, those windows are typically cleaned rather than replaced.

The mechanical manner in which a window is coupled to an enclosure housing may be as simple as a threaded pair; one thread set on the window frame element and another matching thread set on the housing. Screwing the window to the enclosure can provide a stable air tight fit. A replacement window is easily applied when necessary. Alternatively, a mechanical system whereby a cavity is formed at the housing and a properly arranged size and shape window frame is configured to be received in that cavity. In this way, windows are coupled to optics head enclosure housings.

Reflected Wave Cancellation

Other important aspects of windows of these inventions include arrangements to provide an antireflection function to reduce light losses at the window. An optical element is most generally comprised of at least two surfaces each of which produces a reflected wave. By careful positioning of the surfaces with respect to each other, it is possible to cause the reflected waves to be 180 degrees out of phase from the other. In that case, the reflected waves cancel each other causing more energy to be passed through the window. Although use of superposition of reflected waves to achieve reflection cancellation is known in some optical applications such as thin film coatings on bulk elements, the principle cooperates in a unique way with thin windows of polymer as taught here. In particular, techniques of forming these windows include a shrinking step whereby the final thickness of a thin film is carefully set after shrinking to be an odd integer of quarter wavelengths with regard to the design wavelength. So, a thin film of particular thickness and well known shrinking characteristics is applied to a frame. After application of heat and resultant shrinking, the final resting thickness settles to be some odd integer of quarter wavelengths; for example 3. In this way, reflections from the window are greatly reduced via a superposition of coherent waves. While only 3 quarter wavelengths might be exceedingly thin for some preferred windows, the effect is equally strong where 21 quarter wavelengths, or 97 quarter wavelengths are used. Thus where 21 quarter wavelengths are used, after affixing a thin film (somewhat greater than 21 quarter wavelengths to allow for shrinkage) to a frame and shrinking it with the proper application of heat, the film could be 52.5 microns thick in systems having a design wavelength of 10 microns. Experts will agree that other odd integers can be chosen in view of preferred thin film fabrication parameters i.e. pre-shrunk thickness and shrink coefficient.

Condensation Prevention Means

Some versions of these inventions include special means for controlling condensation on the window surfaces. Various strategies might be employed to keep water from condensing on the thin film window surfaces which would otherwise upset the transmission of light therethrough. In a first example, a desiccant can be placed in proximity to the surface to remove water from the air coming in contact therewith. A desiccant such as silica gel can absorb water and pull it away from window surfaces. The desiccant may be kept in a reservoir which may be changed when the material becomes saturated or otherwise expired.

Since warm air can hold more water in vapor than cold air, some versions have a means of heating air and passing it over the window surface to control condensation. Thus a condensation prevention means may be a heater or heating element. Warmed air could be therefore used to control undesirable condensation effects in these windows.

Condensation can also be prevented by heating the film rather that the air. A special version has a heating element integrated with the frame. Since the frame is in thermal contact with the film, heat is quickly transmitted to the film and prevents condensation over the entire surface. An alternative scheme to reduce condensation includes providing a dehumidifier arranged to operate within the enclosure housing whereby water is removed from the air contained therein tending to reduce opportunity for it to condense on the window surface.

In each of these instances, a system is arranged to remove moisture from the window and surroundings where it may prevent good transmission of light. Therefore, it is said that some preferred versions of these windows includes condensation prevention means. Since it is difficult to catalog all possible condensation reduction means possible, it will be understood that whenever the function is performed, the limitation is met.

Methods

With the preceding full and enabling description of devices of these inventions, methods of forming these devices are set forth herefollowing.

In a most generic sense, methods may be characterized as including at least the steps: a) providing a thin film polymer having molecules frozen in a stretched state; b) forming a frame of rigid material to provide a large aperture; c) affixing the polymer material to the frame; d) applying heat to the thin film to encourage the molecules to return towards their relaxed state thus pulling the material tight across the aperture; and e) removing heat and allowing the material to freeze in a taught state.

In addition to those steps, some additional methods may also comprise added steps including: 1) a step to providing the thin film in a thickness which, after application of heat, shrinks to an odd integer number of quarter wavelengths of a design pass wavelength; 2) forming a planar bonding surface of sufficient area to form a secure bond; 3) forming a mechanical coupling in the frame whereby it may be coupled to a cooperating housing enclosure and is removable therefrom; 4) applying an adhesive material between frame and thin film and allowing it to cure; 5) heat bonding the plastic material of the thin film with the material of the frame in a plastic weld; or 6) providing a process step to reduce condensation.

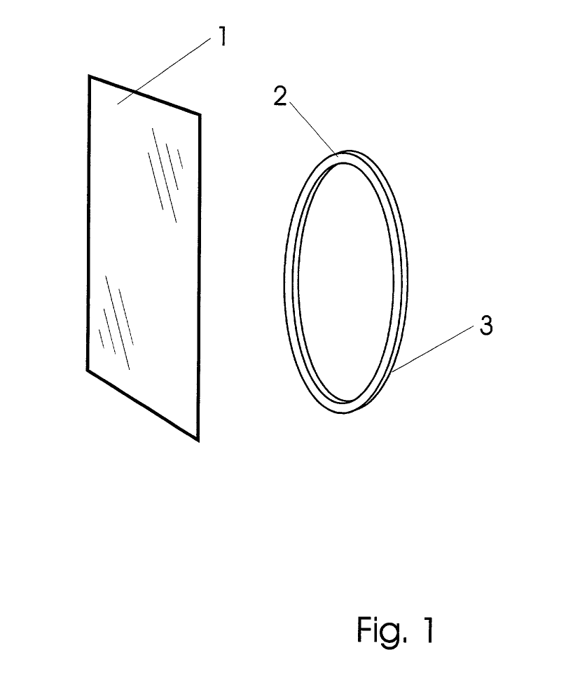

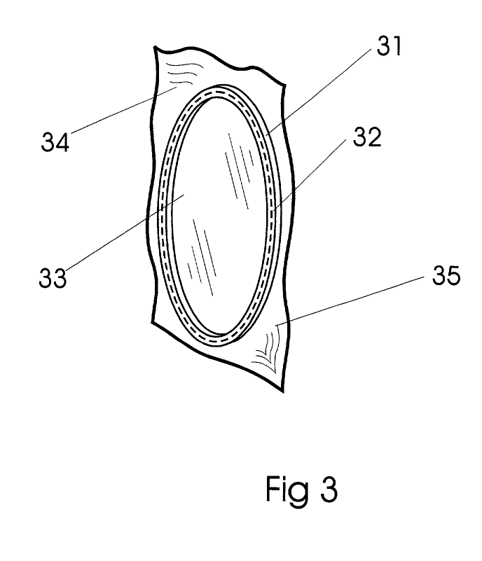

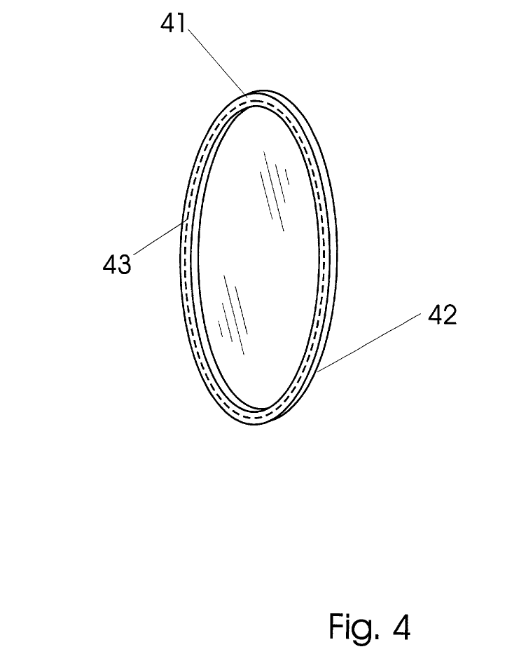

A more complete understanding of these inventions is readily appreciated in view of the following description of examples with reference to drawing figures. In particular, drawing FIG. 1 which illustrates two primary members from which a window may be comprised. A thin film sheet 1 and a rigid frame element 2; in this example and in some preferred embodiments, the rigid frame element is circular in shape, forms a closed loop and has a large area aperture. In addition, it has a special surface 3 which is flat and suitable for receiving and having bonded thereon, the thin film. In the process of forming a barrier window of these inventions, the thin film 21 is brought into contact with frame 22 whereby a bond 23 is formed between the thin film and the frame such that the open area 24 of the frame is completely covered by the thin film. After the bond is set, heat is applied to the combination. The heat causes the molecules in the polymer to return to their natural shape resulting in a shrinking action. The shrinking action tends to pull the film taught over the frame and results in a very flat surface over the open area aperture. FIG. 3 illustrates a frame 31 having a bond 32 and very flat thin film 33 over the large area aperture. The portions of the film outside the frame periphery 34 and 35, may be come wrinkled as those portions are supported in the shrinking process. This is of no consequence whatever as those portions of material are merely trimmed away. Thus FIG. 4 illustrates a completed simple window of this teaching. A bond 41 between a thin film affixed to a circular frame 42 results in a very tight flat surface 43.

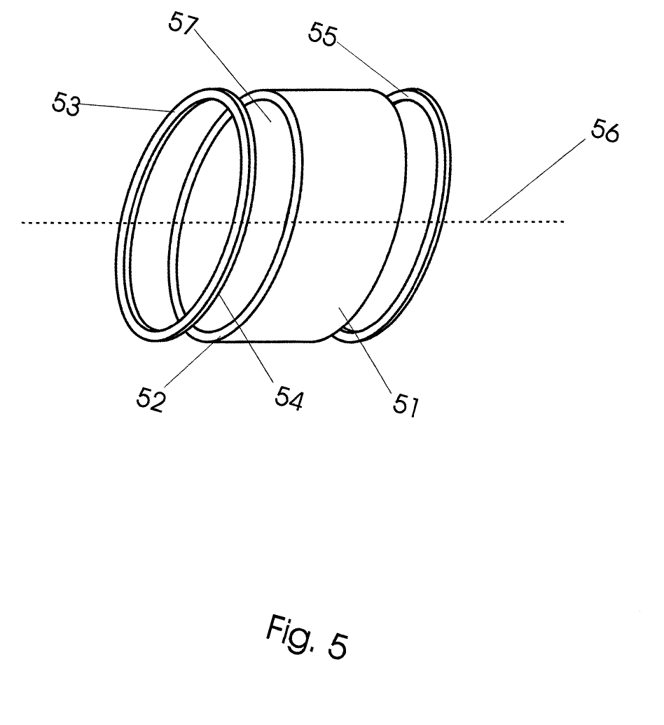

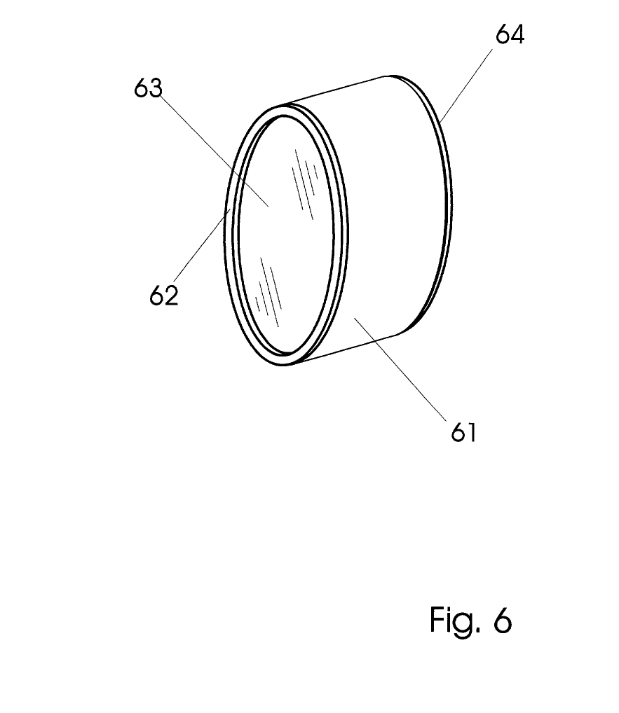

Other preferred versions may include those where a plurality of thin films are affixed to a plurality of frames to result in multiple element, two pane structure. FIG. 5 illustrates a two pane version of a barrier window of these inventions. A cylindrical body element 51 having end 52 can be coupled mechanically to first window 53. This may be achieved via a simple threaded means at the backside 54 surface of the window. Similarly, frame 55 may include a threaded coupling means and may also be coupled to the body element 51 at its other end. The three elements cooperate as they are axially symmetric about axis 56. The interior 57 of the body together with the two panes forms an enclosed cavity when the elements are assembled together as shown in drawing FIG. 6. A barrier window of two panes is shown with a body 61, first frame 62, first thin film 63, second frame 64 and second thin film not shown.

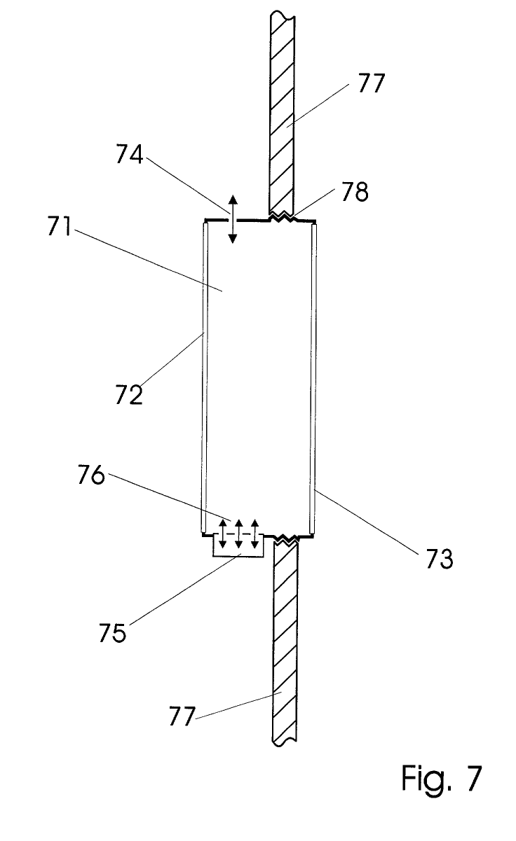

This configuration is important in versions further comprising a condensation reduction means. The interior of the cavity formed by the assembly can be manipulated with regard to the content of water vapor therein in order to prevent condensation which might interrupt transmission of optical beams through the window. In one version of a condensation reduction means, a vent is included whereby conditioned air may be passed into the cavity while removing air having undesirable characteristics. Another version includes a reservoir of desiccant. FIG. 7 illustrates both of these in a cross sectional drawing. A barrier window 71 system of two panes, pane 72 and pane 73, may include a cavity vent 74. In addition, or instead, a reservoir 75 may contain therein a desiccant material which allows water vapor 76 to be drawn to the material. The entire window system can be coupled to an enclosure housing 77 by way of a mechanical fixture such as threads.

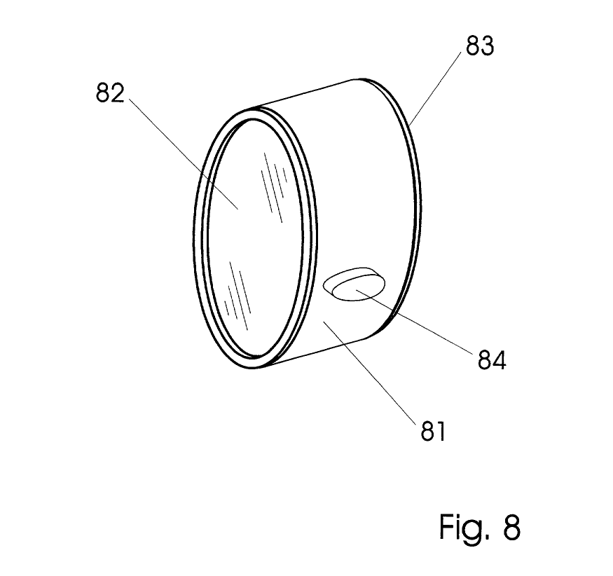

FIG. 8 is a perspective view of the window system separate from any enclosure housing. The body 81 is capped by two panes 82 and 83. Into the side of the body, a reservoir 84 may be provided to control condensation in the cavity by way of an water absorbing material.

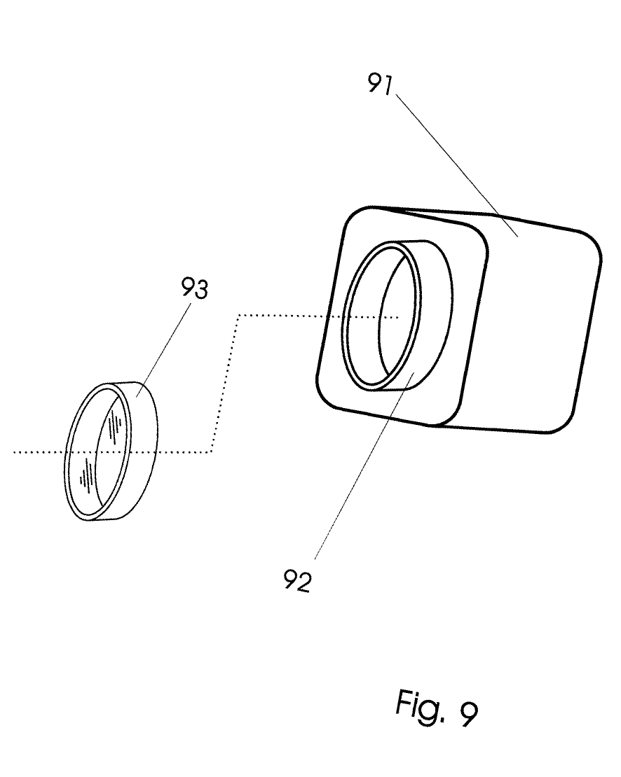

One will gain a greater appreciation for coupling between windows of these inventions and an optical enclosure or housing. An optics head comprises a plurality of elements which are to be protected from an outside environment. The enclosure forms a barrier to prevent contamination of the optics elements contained therein. A window may be provided to pass optical signals from the interior to the exterior. Thus, the complete enclosure is formed when the window is integrated with the housing. FIG. 9 is a simple exploded view perspective drawing to illustrate this further. An enclosure housing 91 includes a mechanical coupling means 92 into which window 93 can be placed and held.

Because some versions of these inventions provide for windows which may be changed from time-to-time, a coupling may include simple operation whereby a user without special skills can remove and replace a window. Figure ten illustrates one version where housing 101 is coupled to a barrier window 102 in a clamshell holder 103 and 104. The parts may be designed such that the holder forms a cavity in which the window is firmly held by virtue of its well matched size and shape.

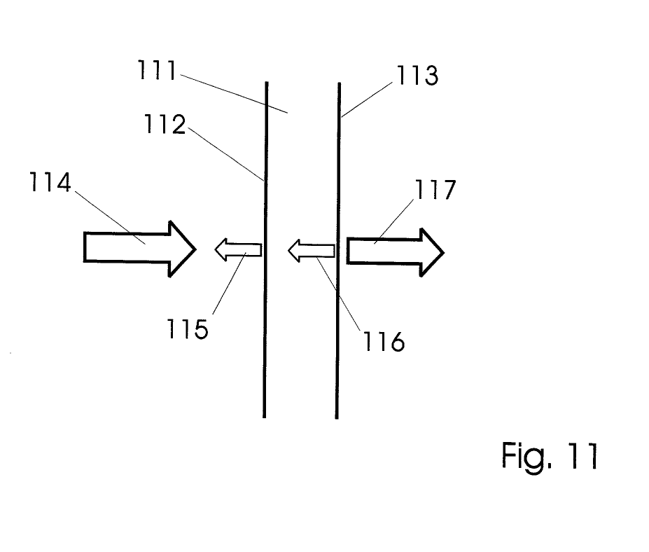

As mentioned, another important aspect of windows of these inventions include arrangements to provide an antireflection function to reduce light losses at the window. FIG. 11 illustrates a beam passing through a single thin window 111 having two surfaces, front surface 112 and back surface 113. An optical beam 114 is incident upon the front surface and produces a first reflected wave 115 in agreement with the boundary conditions of transparent materials. The beam continues in the window material until it is incident upon the back surface where it produces a second reflected wave 116. Finally, the beam 117 leaves the window and propagates normally, albeit reduced a bit in intensity due to the energy coupled into the reflected waves. To reduce the amount of energy in the backward traveling wave, the thickness of a window can be arranged to be an odd quarter multiple of the design wavelength.

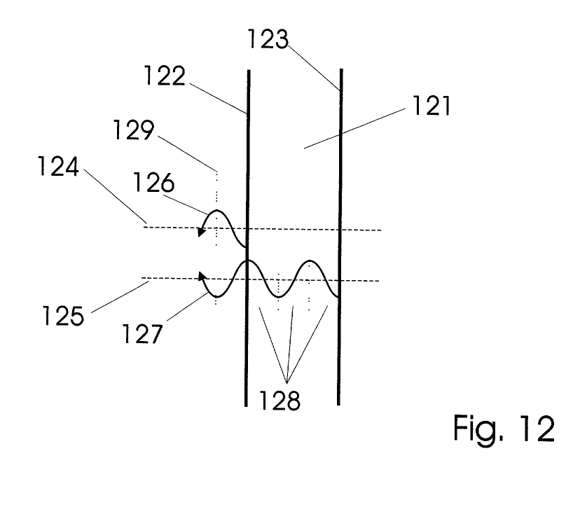

FIG. 12 illustrates further. A window 121 of thin film affixed to a frame and shrunk to perfect size includes a first surface 122 which is about 3 quarter wavelengths 124 from surface 123. The reflected waves 125 and 126 are drawn with their phase represented by a sine wave depiction. The dashed line 127 represents that the phase difference of the two reflected waves is 180 degrees. Because the first wave will necessarily be coherent with respect to the second these wave will follow rules of superposition to destructively combine effectively canceling one another.

One will now fully appreciate how barrier windows for free space optical systems of Mid-IR wavelengths can be manufactured and used. Although the present invention has been described in considerable detail with clear and concise language and with reference to certain preferred versions thereof including the best mode anticipated by the inventor, other versions are possible. Therefore, the spirit and scope of the invention should not be limited by the description of the preferred versions contained therein, but rather by the claims appended hereto.

What is claimed is:

1) a barrier and Mid-IR optical window for a free space optical system comprising at least one frame member and at least one thin film, a first frame member forming a closed loop structure about a substantially open aperture further having a receiving bonding surface upon which a first thin film may be received and bonded whereby said first thin film is affixed to said first frame and extends over the open aperture to form a taught, substantially flat surface.

2) A barrier and Mid-IR optical window of claim 1,
said first frame further comprises a mechanical coupling means whereby said frame may be coupled to an optics head enclosure housing, and
said thin film is a polymer type material comprising molecules in a stressed state whereby polymer molecules are subject to a relaxing force which tends to pull the film taught in a shrinking action.

3) A barrier and Mid-IR optical window of claim 2, said thin film is bonded to said frame by an adhesive compatible with frame material and polymer material.

4) A barrier and Mid-IR optical window of claim 2, bond is plastic weld heat bond whereby these elements are joined together in a melting and fusing process.

5) A barrier and Mid-IR optical window of claim 2, said polymer molecules are stretched from their relaxed state and exert a force on the thin film whereby the thin film tends to be pulled into a plane.

6) A barrier and Mid-IR optical window of claim 2, said mechanical coupling means is a thread set complementary with an enclosure housing thread set.

7) A barrier and Mid-IR optical window of claim 2, said mechanical coupling means is a frame shape and size which cooperates with a receiving cavity of an enclosure housing whereby changing a window is a matter of simple manipulation of parts.

8) A barrier and Mid-IR optical window of claim 1, said window is comprised of two frames and two thin film members separated spatially be a body member.

9) A barrier and Mid-IR optical window of claim 2, further comprises condensation control means in spatial proximity to said thin film whereby condensation on the thin film is reduced.

10) A barrier and Mid-IR optical window of claim 9, said condensation control means is a desiccant reservoir.

11) A barrier and Mid-IR optical window of claim 9, said condensation control means is a heating element.

12) A barrier and Mid-IR optical window of claim 9, condensation control means is a dehumidifier in an optics head enclosure housing.

13) A barrier and Mid-IR optical window of claim 2, thickness of thin film is odd integer number of quarter wavelengths of a system design wavelength.

14) Methods of forming optical windows including:
providing a thin film polymer material highly uniform in thickness, said polymer being comprised of molecules held in a stretched or linearized state;
forming a closed loop frame of rigid material to provide a large area open aperture;
affixing said polymer material to said frame;
applying heat to said thin film polymer to encourage polymer molecules to return towards a relaxed state thereby pulling the material taught across said large area open aperture; and
removing heat and allowing said polymer material to set or freeze in a taught state thereby providing a highly uniform flat surface.

15) Methods of claim 14, where providing a thin film step includes providing a film of thickness which after application of heat shrinks to a thickness about an odd integer number of quarter wavelengths of a design pass wavelength.

16) Methods of claim 14, forming a closed loop frame includes forming a bonding surface in a plane of suitable area whereby a thin film may be affixed thereto in a secure bond.

17) Methods of claim 14, forming a closed loop frame includes forming a mechanical coupling integral with the frame whereby it may be coupled to a cooperating housing enclosure and is removable therefrom.

18) Methods of claim 14, said affixing step is applying an adhesive material between frame and thin film and allowing it to cure.

19) Methods of claim 14, said affixing step is a heat bonding step whereby the plastic material of the thin film is fused with the material from which forms the frame in a plastic weld.

20) Methods of claim 14, said providing a thin film is forming a film of calculated uniform thickness in view of shrinking properties whereby after heating step the material is odd integral of quarter wavelengths

21) Methods of claim 14, further comprising a process step to reduce provide a condensation reduction means.
